(19) United States
(12) Patent Application Publication
(10) Pub. No.: US 2024/0054018 A1
(43) Pub. Date: Feb. 15, 2024

(54) REDUCING NETWORK OVERHEAD

(71) Applicant: INTERNATIONAL BUSINESS MACHINES CORPORATION, ARMONK, NY (US)

(72) Inventors: Xiao Zhen Zhu, Beijing (CN); Xiao Ling Chen, Beijing (CN); Yuan Yuan, Beijing (CN); Xiao Ming Liu, Beijing (CN); Ming Dong, Beijing (CN); Shao Fei Li, Beijing (CN)

(21) Appl. No.: 17/818,725

(22) Filed: Aug. 10, 2022

(51) Int. Cl. G06F 9/50

(52) U.S. Cl. CPC G06F 9/5027

(57) ABSTRACT

A computer-implemented method includes receiving an initial request from a client, splitting the initial request into a plurality of split requests based on a business logic, acquiring mapping information associated with the plurality of split requests, determining, based, at least in part, on the mapping information, respective split requests included in the plurality of split requests that are candidates for merger into a merged request, merging the respective split requests that are determined to be candidates for merger into one or more merged requests, and sending the one or more merged requests to one or more nodes capable of processing the one or more merged requests.

### BACKGROUND

The present invention relates to micro-service architecture, and more specifically, to reducing network overhead within a micro-service architecture.

The Micro-service architecture has become hugely popular because it can address many current IT challenges like scalability, independent evolution, high availability, and the like. Container based applications and container orchestration have further made the micro-service architecture much easier to be implemented.

Generally, when people transform a monolithic architecture to a micro-service architecture, a large number of micro-services may be generated. Each micro-service needs to be processed, which means a large number of remote calls. This results in increased network latency, which sometimes may even produce higher costs than in a traditional monolithic architecture.

Patent publication CN113722070A (Zhang, 2021) discloses a method to improve the performance of a micro-service system using a service grid architecture. In patent publication CN113064712A (Chen, 2021), a micro-service optimization deployment control method is disclosed, in which the method includes monitoring the resource use condition of each node and migrating the micro-service from a congested node to other idle nodes when the resource use is unbalanced. However, none of the references fairly teach or suggest reducing network overhead based on merging requests.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Embodiments of the present disclosure provide a computer-implemented method, computer program product, and computer system that may reduce the network latency in a micro-service architecture, which may improve the stability and robustness of the micro-service architecture, and significantly reduces the interactions between an API gateway and a cluster of containers.

According to one embodiment of the present invention, a computer-implemented method is disclosed. The computer-implemented method includes receiving, by one or more processors, an initial request from a client. The computer-implemented further includes splitting, by one or more processors, the initial request into a plurality of split requests based on a business logic. The computer-implemented method further includes acquiring, by one or more processors, mapping information associated with the plurality of split requests. The computer-implemented method further includes determining, by one or more processors, based, at least in part, on the mapping information, respective split requests included in the plurality of split requests that are candidates for merger into a merged request. The computer-implemented method further includes merging, by one or more processors, the respective split requests that are determined to be candidates for merger into one or more merged requests. The computer-implemented method further includes sending, by one or more processors, the one or more merged requests to one or more nodes capable of processing the one or more merged requests.

According to another embodiment of the present invention, a computer program product is disclosed. The computer program product includes one or more computer readable storage media and program instructions stored on the one or more computer readable storage media. The program instructions include instructions to receive an initial request from a client. The program instructions further include instructions to split the initial request into a plurality of split requests based on a business logic. The program instructions further include instructions to acquire mapping information associated with the plurality of split requests. The program instructions further include instructions to determine, based, at least in part, on the mapping information, respective split requests included in the plurality of split requests that are candidates for merger into a merged request. The program instructions further include instructions to merge the respective split requests that are determined to be candidates for merger into one or more merged requests. The program instructions further include instructions to send the one or more merged requests to one or more nodes capable of processing the one or more merged requests.

According to another embodiment of the present invention, a computer system is disclosed. The computer system includes one or more computer system includes one or more computer processors, one or more computer readable storage media, and program instructions stored on the computer readable storage media for execution by at least one of the one or more processors. The program instructions include instructions to receive an initial request from a client. The program instructions further include instructions to split the initial request into a plurality of split requests based on a business logic. The program instructions further include instructions to acquire mapping information associated with the plurality of split requests. The program instructions further include instructions to determine, based at least in part on the mapping information, respective split requests included in the plurality of split requests that are candidates for merger into a merged request. The program instructions further include instructions to merge the respective split requests that are determined to be candidates for merger into one or more merged requests. The program instructions further include instructions to send the one or more merged requests to one or more nodes capable of processing the one or more merged requests.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 is a block diagram depicting components of a cloud computing node, generally designated 100, suitable for executing at least one embodiment of the present invention.

FIG. 2 is a block diagram depicting a cloud computing environment, generally designated 50, in accordance with at least one embodiment of the present invention.

FIG. 3 is a block diagram depicting abstraction model layers in accordance with at least one embodiment of the present invention.

FIG. 4 is a block diagram of a first cluster 400 including micro-services in accordance with at least one embodiment of the present invention.

FIG. 5 is a block diagram of a first API gateway 500 in a distributed computing framework in accordance with at least one embodiment of the present invention.

FIG. 6 is a functional block diagram illustrating an example of a request transmitted within a micro-service architecture of a distributed computing framework, generally designated 600, in accordance with at least one embodiment of the present invention.

FIG. 7 is a functional block diagram illustrating an example of a response to the request transmitted within the micro-service architecture of the distributed computing framework depicted in FIG. 6, generally designated 700, in accordance with at least one embodiment of the present invention.

FIG. 8 is a block diagram of a second API gateway 800 in a distributed computing framework in accordance with at least one embodiment of the present invention.

FIG. 9 is a block diagram of a second cluster 900 including one or more request and response assembly modules and one or more response assembling modules in accordance with at least one embodiment of the present invention.

FIG. 10 is a functional block diagram of a first micro-service architecture within a distributed computing framework, generally designated 1000, including API gateway 800 depicted in FIG. 8 and second cluster 900 depicted in FIG. 9 in accordance with at least one embodiment of the present invention.

FIG. 11 is a functional block diagram of a second micro-service architecture within a distributed computing framework, generally designated 1100, including API gateway 800 depicted in FIG. 8 and second cluster 900 depicted in FIG. 9 in accordance with at least one embodiment of the present invention.

FIG. 12 is a flowchart diagram, generally designated 1200, depicting a method for reducing network latency in a micro-service architecture within a distributed computing framework in accordance with at least one embodiment of present invention.

FIG. 13 is a block diagram, generally designated 1300, depicting respective corresponding operational steps of the flowchart diagram 1200 of FIG. 12 in accordance with at least one embodiment of the present invention.

### DETAILED DESCRIPTION

According to embodiments of the present disclosure, a computer-implemented method, computer program product, and computer system are provided that reduce network workload within a micro-service architecture, which may improve the stability and robustness of the micro-service architecture itself. According to an embodiment of the present invention, by splitting an initial request into a plurality of split requests, and remerging respective split requests into one or more merged requests based on mapping information associated with the split requests, the interaction between an API gateway and a cluster may be significantly reduced. In an embodiment, the mapping information further includes health information (e.g., CPU utilization and failure rates corresponding to particular time periods) of nodes capable of processing the merged requests, increased stability of the micro-service architecture may be achieved by only sending the merged requests to healthy nodes.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

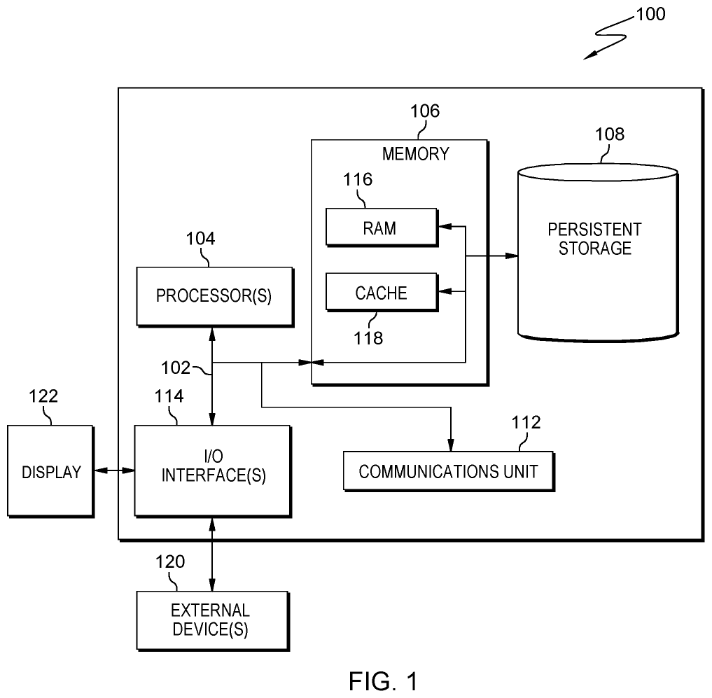

FIG. 1 is a block diagram depicting components of a cloud computing node, generally designated 100, suitable for executing at least one embodiment of the present invention. Cloud computing node 100 includes one or more processor(s) 104 (including one or more computer processors), communications fabric 102, memory 106 including, RAM 116 and cache 118, persistent storage 108, communications unit 112, I/O interface(s) 114, display 122, and external device(s) 120. It should be appreciated that FIG. 1 provides only an illustration of one embodiment and does not imply any limitations with regard to the environments in which different embodiments may be implemented. Many modifications to the depicted environment may be made.

As depicted, cloud computing node 100 operates over communications fabric 102, which provides communications between computer processor(s) 104, memory 106, persistent storage 108, communications unit 112, and input/output (I/O) interface(s) 114. Communications fabric 102 can be implemented with any architecture suitable for passing data or control information between processor(s) 104 (e.g., microprocessors, communications processors, and network processors), memory 106, external device(s) 120, and any other hardware components within a system. For example, communications fabric 102 can be implemented with one or more buses.

Memory 106 and persistent storage 108 are computer readable storage media. In the depicted embodiment, memory 106 includes random-access memory (RAM) 116 and cache 118. In general, memory 106 can include any suitable volatile or non-volatile one or more computer readable storage media.

Program instructions for carrying out embodiments of the present invention can be stored in persistent storage 108, or more generally, any computer readable storage media, for execution by one or more of the respective computer processor(s) 104 via one or more memories of memory 106. Persistent storage 108 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 108 may also be removable. For example, a removable hard drive may be used for persistent storage 108. Other examples include optical and magnetic disks, thumb drives, and smart cards that are inserted into a drive for transfer onto another computer readable storage medium that is also part of persistent storage 108.

Communications unit 112, in these examples, provides for communications with other data processing systems or devices. In these examples, communications unit 112 can include one or more network interface cards. Communications unit 112 may provide communications through the use of either or both physical and wireless communications links. In the context of some embodiments of the present invention, the source of the various input data may be physically remote to cloud computing node 100 such that the input data may be received, and the output similarly transmitted via communications unit 112.

I/O interface(s) 114 allows for input and output of data with other devices that may operate in conjunction with cloud computing node 100. For example, I/O interface(s) 114 may provide a connection to external device(s) 120, which may be as a keyboard, keypad, a touch screen, or other suitable input devices. External device(s) 120 can also include portable computer readable storage media, for example thumb drives, portable optical or magnetic disks, and memory cards. Software and data used to practice embodiments of the present invention can be stored on such portable computer readable storage media and may be loaded onto persistent storage 108 via I/O interface(s) 114. I/O interface(s) 114 also can similarly connect to display 122. Display 122 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

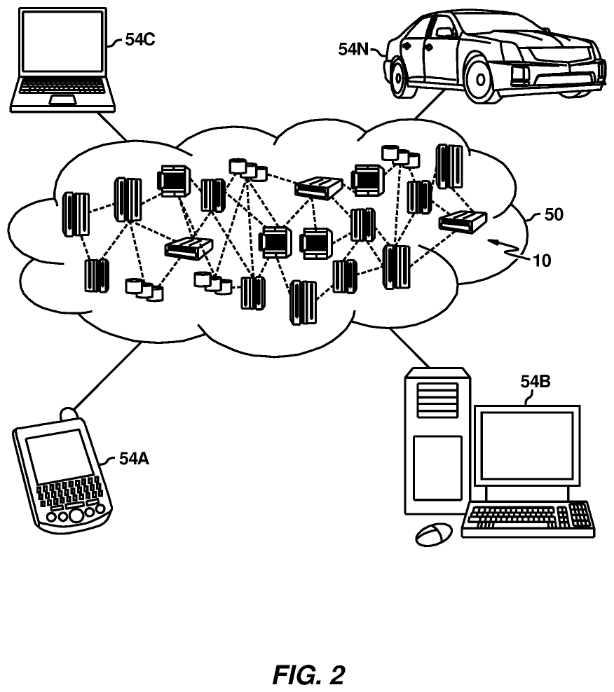

FIG. 2 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

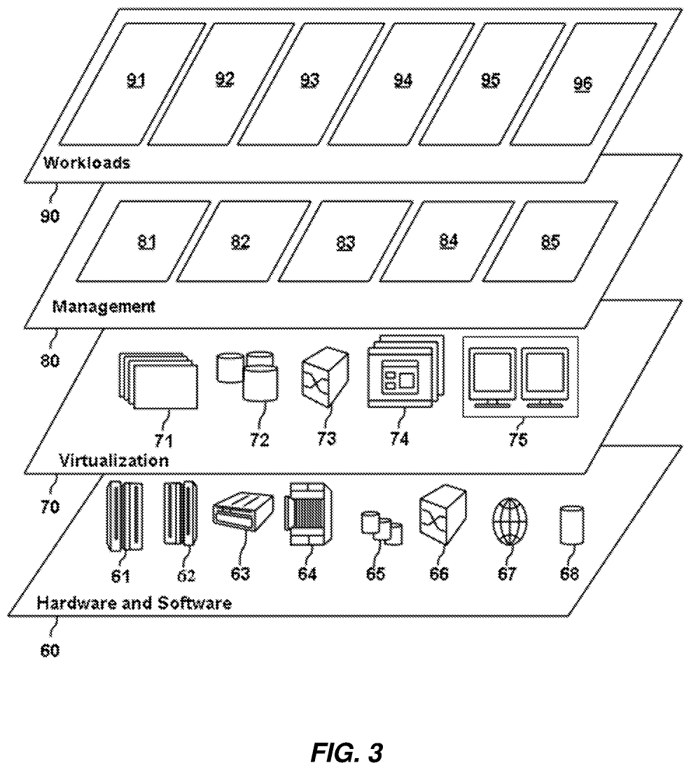

FIG. 3 is block diagram depicting a set of functional abstraction model layers provided by cloud computing environment 50 depicted in FIG. 2 in accordance with at least one embodiment of the present invention. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and micro-service request and response merging 96.

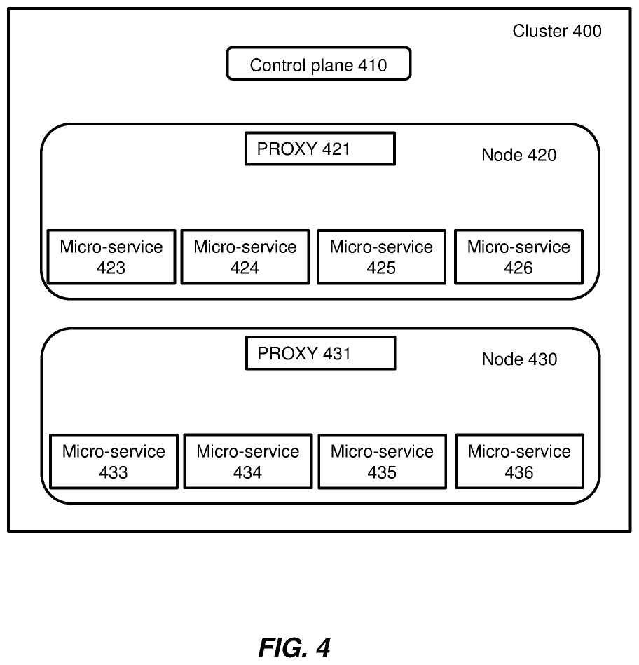

FIG. 4 is a block diagram of a first cluster 400 including micro-services in accordance with at least one embodiment of the present invention. Typically, micro-services can be deployed, for example, in a virtualization entity in a cloud computing framework. The virtualization entity may be, for example, a Virtual machine, a Docker container, a cluster container, or the like. A cluster container (hereinafter referred to as cluster for brevity) may be described below with reference to FIG. 4 as an example virtualization entity.

In some embodiments, cluster 400 may be a container optimized by a choreography tool, and the choreography tool may be Kubernetes (K8S), Nomad, docker swarm, or the like. The cluster 400 may include a control plane and a plurality of node containers. The control plane may be in charge of making global decisions about the cluster 400, for example, scheduling, detecting, and responding to cluster events. One or more micro-services may be deployed in the node containers. For example, as shown in FIG. 4, the cluster 400 may be a Kubernetes (K8S) cluster. The control plane 410 may manage node container 420 and node container 430 (hereinafter referred to as node 420 and node 430). Micro-services 423, 424, 425, 426 may be deployed in node 420, and micro-services 433, 434, 435, 436 may be deployed in node 430. Moreover, in each node, there may be a proxy, for example, proxy 421 for node 420 and proxy 431 for node 430. The proxy can be a network proxy running on each node in the cluster which may be in charge of managing node resources, such as arranging requests to the target micro-services, receiving requests and responses, forwarding requests and responses, or the like. It should be noted that the number of control planes, nodes, proxies, and micro-services in cluster 400 may vary based on actual needs, and should not be limited herein. Other nodes may also be included in the cluster 400, but are not depicted for brevity. In some embodiments, the cluster 400 may be implemented as part of the cloud computing framework.

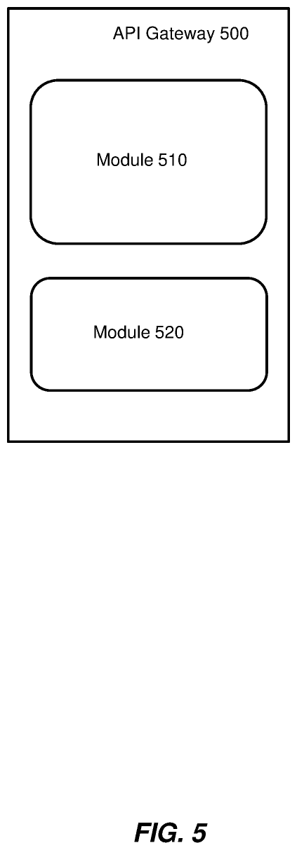

In some embodiments, a micro-service can expose its endpoints through an application programming interface (API). The API may be a list of all endpoints that the micro-service responds to when it receives a command or query. The endpoints are resources that get IP addresses of one or more containers or clusters dynamically assigned to it. Each micro-service may contain its respective endpoints and other internal modules which are used to process requests. For better management, an additional layer may be introduced between the clients and services (for example, clusters), acting as a proxy for routing requests from the client to the service and forwarding corresponding responses back to the client. Specific details for the additional layer may be described hereinafter, for example, with respect to an API gateway 500 in FIG. 5.

FIG. 5 is a block diagram of a first API gateway 500 in a distributed computing framework in accordance with at least one embodiment of the present invention. Generally, the API gateway 500 may include a module 510 which is in charge of receiving a client request from the client and splitting the client request into a plurality of split requests that will be processed by different micro-services according to business logic. Moreover, the API gateway 500 may also include a module 520 which is in charge of receiving a response from a cluster and sending the response back to the client. The API gateway 500 may further include other modules based on actual needs and will be explained hereinafter.

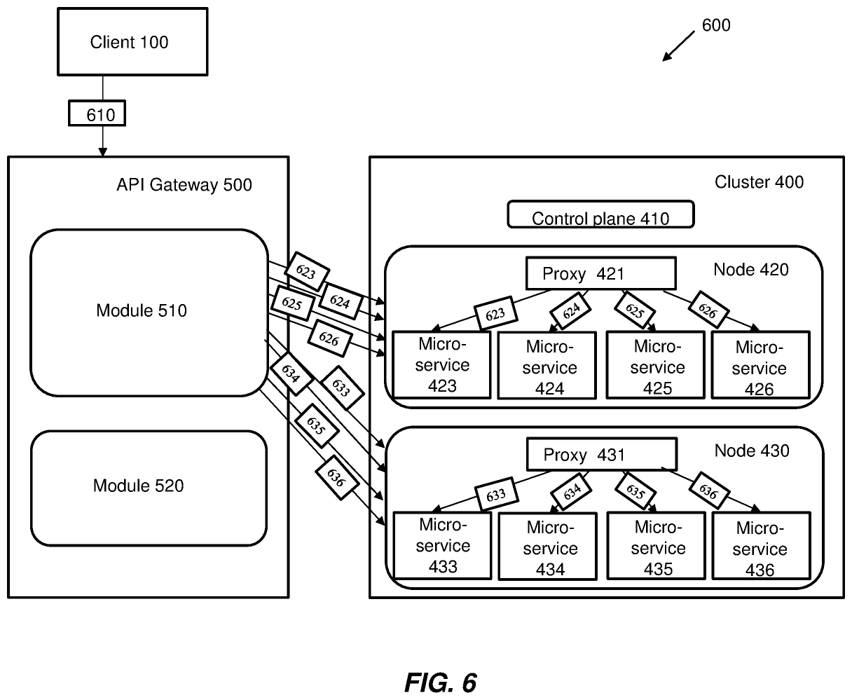

FIG. 6 is a functional block diagram illustrating an example of a request transmitted within a micro-service architecture of a distributed computing framework, generally designated 600, in accordance with at least one embodiment of the present invention. In some embodiments, a structure and function of the cluster 400 and API gateway 500 in FIG. 6 may be similar to that of in FIG. 4 and FIG. 5. Thus, same or similar numbers denote same or similar components, and same or similar descriptions will be omitted.

As shown in FIG. 6, a client 100 may send a request 610 to the API gateway 500. The request may include one or more different requests according to business logic. For example, module 510 may split the request 610 into eight requests 623, 624, 625, 626, 633, 634, 635, 636 based on business logic, which correspondingly refer to different micro-services. It can be understood the number of split requests may be varied based on actual needs and should not be limited herein. Each micro-service may have its own endpoint(s) as an identification to communicate with other components or entities in the distributed computing framework. The endpoints can be represented by numbers, letters, words, or the like. In some embodiments, numbers are used for brevity, such as, for micro-service 423, “423” is also used as the endpoint of the micro-service. Similar applications may be applied to other micro-services. For example, “424”, “425”, “426”, “433”, “434”, “435”, “436” represent the endpoints of micro-services 424, 425, 426, 433, 434, 435, 436, respectively.

After splitting the request 610, module 510 may send the split requests, for example, the requests 623, 624, 625, 626, 633, 634, 635, 636 to the target nodes.

An exemplary service list received from the client, and requests sent by module 510 to cluster 400 are provided below as Example 1.

### Example 1

### Service List

423, 424, 425, 426, 433, 434, 435, 436

| | | Dynamic |
|---|---|---|
| | | assigned |
| RequestIDs | Request URL | nodeIDs |
| 623 | Https://dataplatform.cloud.ibm.com/api/423 | Node 420 |
| 624 | Https://dataplatform.cloud.ibm.com/api/424 | Node 420 |
| 625 | Https://dataplatform.cloud.ibm.com/api/425 | Node 420 |
| 626 | Https://dataplatform.cloud.ibm.com/api/426 | Node 420 |
| 633 | Https://dataplatform.cloud.ibm.com/api/433 | Node 430 |
| 634 | Https://dataplatform.cloud.ibm.com/api/434 | Node 430 |
| 635 | Https://dataplatform.cloud.ibm.com/api/435 | Node 430 |
| 636 | Https://dataplatform.cloud.ibm.com/api/436 | Node 430 |

As described above, the information contained in the above requests may include requestIDs (for example, 623, 624), URLs, and the nodeIDs (for example, Node 420, Node 430) to be assigned.

After receiving the split requests from module 510, proxy 421, which is deployed on node 420, may distribute each of the requests to corresponding microservices based on the information provided in the requests. For example, micro-services 423, 424, 425, 426 may process requests 623, 624, 625, 626, respectively, and proxy 431, which is deployed on node 430, may assign micro-services 433, 434, 435, 436 to process requests 633, 634, 635, 636, respectively. It should be noted that each microservice may handle more than one request. Contents, category, and number of requests which a microservice may support can vary based on actual needs and should not be limited herein.

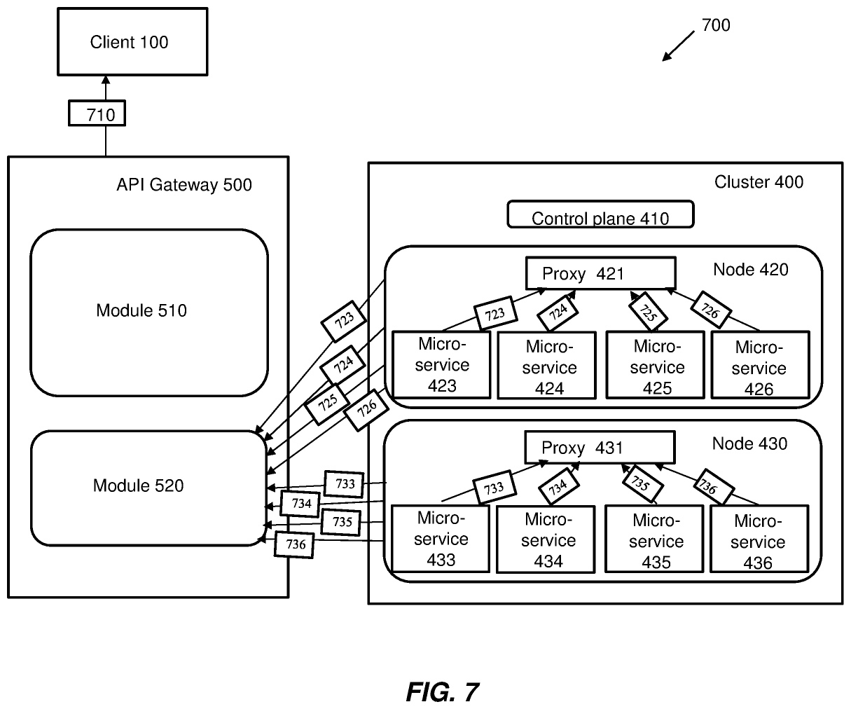

FIG. 7 is a functional block diagram illustrating an example of a response to the request transmitted within the micro-service architecture of the distributed computing framework depicted in FIG. 6, generally designated 700, in accordance with at least one embodiment of the present invention. In some embodiments, a structure and function of cluster 400 and API gateway 500 in FIG. 7 may be similar to that of in FIGS. 4-6.

As shown in FIG. 7, in some embodiments, after being processed by micro-services 423, 424, 425, 426, responses 723, 724, 725, 726 corresponding to requests 623, 624, 625, 626 may be gathered and forwarded by proxy 421 to module 520. Responses 733, 734, 735, 736 may be processed similarly, and as such, repeated descriptions are omitted.

After processing the requests, responses are generated by the micro-services deployed in the cluster 400 in the cloud computing environment. However, as described above, based on the micro-service architecture 600 and 700, for example, one request from a client can be split into several (e.g., eight) requests that are sent from API gateway 500 to nodes in cluster 400. Accordingly, network latency may be increased as compared to a monolithic architecture. Thus, an architecture that can offer more flexibility and be independently evolved without a steep increase in network latency as compared to a monolithic architecture is desired.

Embodiments of the present disclosure provide a computer-implemented method, computer program product, and computer system that reduces network latency network latency and suppresses network overhead by merging a plurality of requests or responses into one or more merged requests or one or more merged responses.

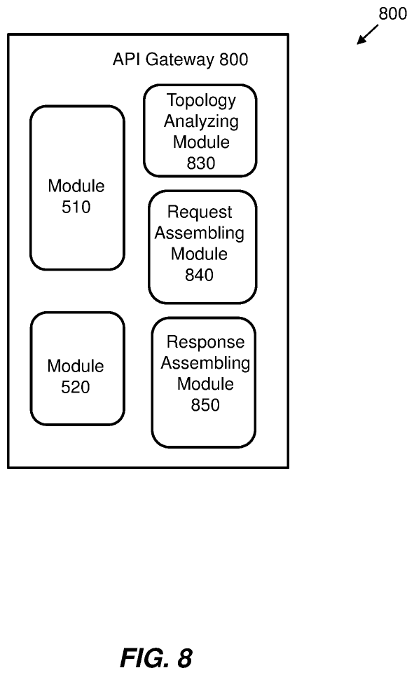

FIG. 8 is a block diagram of a second API gateway 800 in a distributed computing framework in accordance with at least one embodiment of the present invention. Topology analyzing module 830, request assembling module 840, and response assembling module 850 may be further included in API gateway 800 as depicted in FIG. 8. In some embodiments, topology analyzing module 830 can be utilized to send a request to the control plane of cluster 400 to acquire a topology of services, such as mapping relationships between the requests and the nodes, the health status of the node (for example, CPU utilization, failure rate in certain time span, such as, in the past 1 hour, in the past 30 minutes, in the past 20 minutes, in the past 10 minutes, etc.), or the like. In some embodiments, request assembling module 840 can be used to determine, based on the mapping information acquired by topology analyzing module 830, which requests are suitable candidate requests, and to send the candidate requests to the corresponding nodes. In some embodiments, response assembling module 850 can be used to assemble the responses according to needs of module 520.

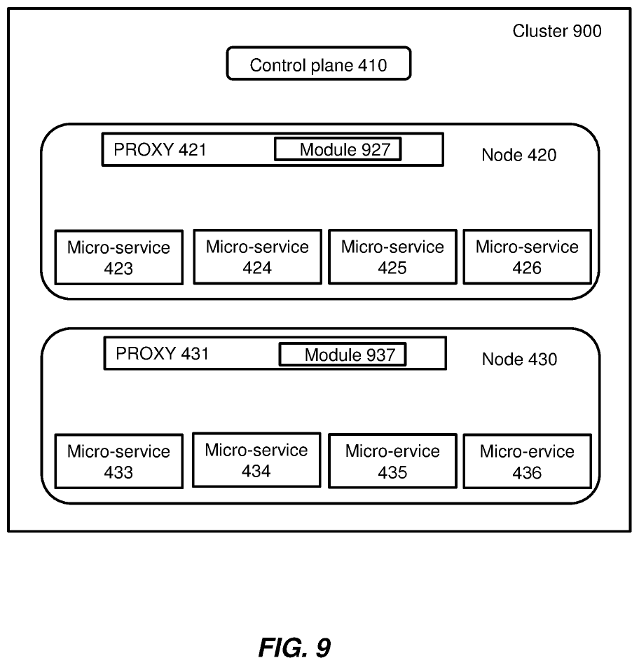

FIG. 9 is a block diagram of a second cluster 900 including one or more request assembly modules and one or more response assembling modules in accordance with at least one embodiment of the present invention. In some embodiments, after receiving the merged requests, nodes 420 and 430 of cluster 900 may process the merged requests. A request and response assembling module (for example, module 927, module 937) may be deployed in each proxy implemented in every node to split the merged requests into normal requests (for example, split requests 623-626) and then send the normal requests to each of the micro-services. In some embodiments, module 927 may be deployed in proxy 421, and module 937 may be deployed in proxy 431. A structure and function of cluster 900 and cluster 400 in FIG. 4 may be similar, and thus, similar repeated descriptions of cluster 900 are omitted for brevity.

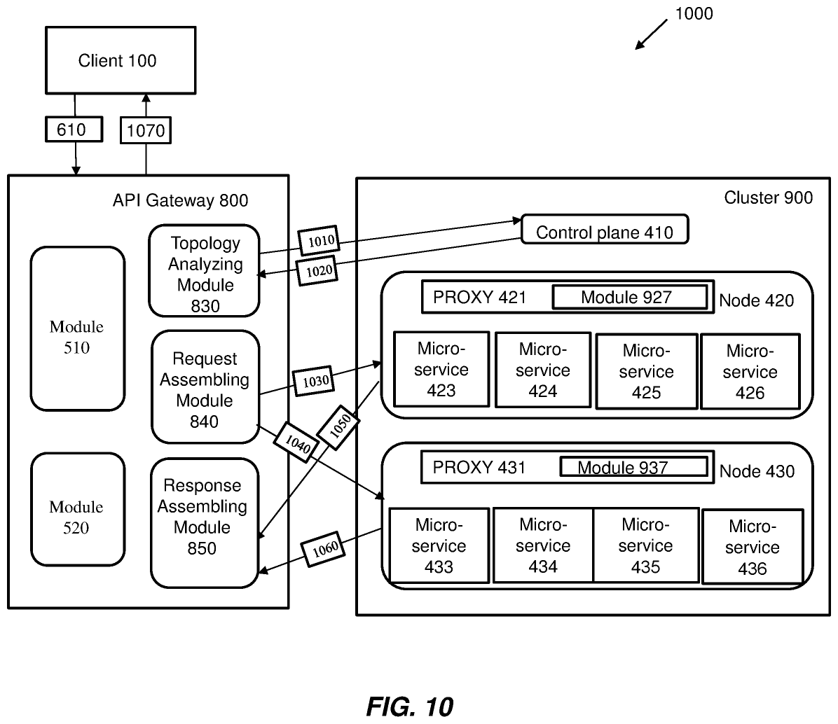

FIG. 10 is a functional block diagram of a first micro-service architecture within a distributed computing framework, generally designated 1000, including API gateway 800 depicted in FIG. 8 and second cluster 900 depicted in FIG. 9 in accordance with at least one embodiment of the present invention. As shown in FIG. 10, after module 510 obtains the request list for request 610 and splits the request 610 into several requests (for example, similar to FIG. 6), topology analyzing module 830 may send a request 1010 to control plane 410 for mapping information of the services related to the request 610. A response 1020 associated with the mapping information may be given, such as mapping relationships between the requests and the nodes, the health status of the node (for example, CPU utilization, failure rate in certain time span, such as, in the past 1 hour, in the past 30 minutes, in the past 20 minutes, in the past 10 minutes and etc.) or the like.

An example service list, request list, request 1010 and response 1020 is provided below as Example 2.

### Example 2

### Service List

423, 424, 425, 426, 433, 434, 435, 436

| RequestIDs | Request URL |
|---|---|
| 623 | Https://dataplatform.cloud.ibm.com/api/423 |
| 624 | Https://dataplatform.cloud.ibm.com/api/424 |
| 625 | Https://dataplatform.cloud.ibm.com/api/425 |
| 626 | Https://dataplatform.cloud.ibm.com/api/426 |
| 633 | Https://dataplatform.cloud.ibm.com/api/433 |
| 634 | Https://dataplatform.cloud.ibm.com/api/434 |
| 635 | Https://dataplatform.cloud.ibm.com/api/435 |
| 636 | Https://dataplatform.cloud.ibm.com/api/436 |

Request 1010:

URL: Https://dataplatform.cloud.ibm.com/apis/currentNodeServiceMap

Body:

{
“service list”: [ 423, 424, 425, 426, 433, 434, 435, 436],
}

Response 1020:
Body: {“423”: “Node 420”, “424”: “Node 420”, “425”: “Node 420”, “426”: “Node 420”, “433”: “Node 430”, “434”: “Node 430”, “435”: “Node 430”, “436”: “Node 430”,}

As described in previous paragraphs, for example, “424” “425” “426” “433” “434” “435” “436” are the endpoints of the micro-services 424, 425, 426, 433, 434, 435, 436. From the response 1020, API gateway 800 may have the information about mapping information (e.g., services 423, 424, 425, 426 will be assigned to Node 420, and services 433, 434, 435, 436 will be assigned to Node 430, etc).

Moreover, after receiving the response 1020 from control plane 410, request assembling module 840 may merge requests based on the mapping information (e.g., mapping relationships between the requests and the nodes). As it is received from the request 1010, requests 623, 624, 625, 626 may be assigned to node 420, and requests 633, 634, 635, 636 may be assigned to node 430. Based on the above information, request assembling module 840 may determine to select requests 623, 624, 625, 626 as candidate requests for merging because of the above requests mapping to a same node 420. A similar determination may be made for requests 633, 634, 635, 636, and as such, repeated explanations are omitted for brevity. For example, requests 623, 624, 625, 626 which will be processed by node 420 may be merged into a merged request 1030, and requests 633, 634, 635, 636 which will be processed by node 430 may be merged into a merged request 1040. A mergedID may be an identification which is used to identify merged requests and merged responses. The merged requests and corresponding merged responses may share the same mergedIDs.

Exemplary merged requests 1030 and 1040 sent by module 510 to cluster 400 is provided below as Example 3.

### Example 3

### Request 1030

URL:

Https://dataplatform.cloud.ibm.com/nodeProxy/mergedRequest

Header:
mergedID:278904859109847365827568472649

Body:

```
    {
  “requestlist”:[
    {
      “url”:” Https://dataplatform.cloud.ibm.com/api/423”,
      “method”:”get”
      }, {
      “url”:”Https://dataplatform.cloud.ibm.com/api/424”,
      “method”:”post”
      “body”:”...”
    }, {
      “url”:”Https://dataplatform.cloud.ibm.com/api/425”
      “method”:”delete”
    }, {
      “url”:”Https://dataplatform.cloud.ibm.com/api/426 ”
      “body”:”...”
    },
  ]
}
```

### Request 1040

URL:
Https://dataplatform.cloud.ibm.com/nodeProxy/mergedRequest

Header:

mergedID: 83627ddfgv8e7g9v92nb409734bbvjsq

Body:

```
{
  “requestlist”:[
    {
      “url”:”Https://dataplatform.cloud.ibm.com/api/433”,
      “method”:”get”
      }, {
      “url”:”Https://dataplatform.cloud.ibm.com/api/434”,
      “method”:”post”
      “body”:”...”
    }, {
      “url”:”Https://dataplatform.cloud.ibm.com/api/435”
      “method”:”delete”
    }, {
      “url”:”Https://dataplatform.cloud.ibm.com/api/436 ”
      “body”:”...”
    },
  ]
}
```

As shown above, requests 1030 or 1040 may include the URL of the destination node, mergedID, and the request list of the associated requests.

As shown on the right side of FIG. 10, in some embodiments, after receiving the request 1030 from request assembling module 840, module 927 deployed on proxy 421 may split the request 1030 into normal requests (for example, requests 623, 624, 625, 626). Request 1040 may be split into requests 633, 634, 635, 636 by module 937 deployed on proxy 431 as well. The process of how requests 623, 624, 625 626 are processed by the respective micro-service, and responses 723, 724, 725, 726 to said requests may be similar to the operations described in FIG. 6 and FIG. 7, and thus, similar repeated descriptions are omitted.

Responses 723, 724, 725, 726 may be collected by module 927, merged into a single merged response 1050, and the merged response 1050 sent to response assembling module 850. In a similar way, responses 733, 734, 735, 736 may be processed into a single merged response 1060 and the merged response 1060 sent to response assembling module 850. For the sake of simplicity, the corresponding process of sending requests 623, 624, 625, 626, 633, 634, 635, 636 to respective micro-services, and receiving responses 723, 724, 725, 726, 733, 734, 735, 736 from the respective micro-services are not shown in FIG. 10 as the operations are same as that described with respect to FIG. 6 and FIG. 7, respectively.

In some embodiments, response assembling module 850 may receive merged response 1050 and merged response 1060 and process merged response 1050 and merged response 1060 according to the needs of module 520. For example, response assembling module 850 may merge merged responses 1050 and 1060 into a merged response 1070, which may also be referred to as a “final response” or “final merged response.” The merged response 1070, which in this case is the final response, may be sent to module 520. Finally, module 520 may send the merged response 1070 (“final response”) back to the client.

Exemplary normal requests 623, 624, 625, 626, 633, 634, 635 636 on nodes 420 and 430, merged response 1050, merged response 1060, and merged response 1070 is provided below as Example 5.

### Example 5

### In Node 420:

| RequestsIDs | Request URL |
|---|---|
| 623 | Https://dataplatform.cloud.ibm.com/api/423 |
| 624 | Https://dataplatform.cloud.ibm.com/api/424 |
| 625 | Https://dataplatform.cloud.ibm.com/api/425 |
| 626 | Https://dataplatform.cloud.ibm.com/api/426 |

### In Node 430:

| RequestsIDs | Request URL |
|---|---|
| 633 | Https://dataplatform.cloud.ibm.com/api/433 |
| 634 | Https://dataplatform.cloud.ibm.com/api/434 |
| 635 | Https://dataplatform.cloud.ibm.com/api/435 |
| 636 | Https://dataplatform.cloud.ibm.com/api/436 |

### Merged Response 1050:

{
“mergedID”: “278904859109847365827568472649”,
“result1”:{...},
“result2”:{...},
“result3”:[ , ,...],
“result4”:{...}
}

### Merged Response 1060:

{
“mergedID”:”83627ddfgv8e7g9v92nb409734bbvjsq”,
“result1”:{...},
“result2”:{...},
“result3”:[ , ,...],
“result4”:{...}
}

### Merged Response 1070:

{
“result1”:{...},
“result2”:{...},
“result3”:[ , ,...],
“result4”:{...},
“result5”:true,
“result6”:{...},
“result7:”value”,
“result8 ”:[ , ,...]
}

As shown above, merged responses 1050 or 1060 may include the mergedID and results corresponding to the mergedID, and the merged response 1070 may include all the results associated with initial request 610.

It should be noted that the URLs, the mergedIDs, the actions, and the results shown in Examples 1-5 may vary based on the actual needs of module 520 and should not be limited herein.

As described above, and with reference to FIG. 6 and FIG. 7, the network between an API gateway and a cluster may be very crowded, resulting in increased network latency. This stems from the fact that current micro-service architectures divide requests into multiple requests that target different micro-services. However, by employing the request assembling module 840 in accordance with embodiments of the present invention, merging some of the requests may decrease the quantity of interactions between an API gateway and a cluster, thereby decreasing the network workload and as a result, decreasing network latency.

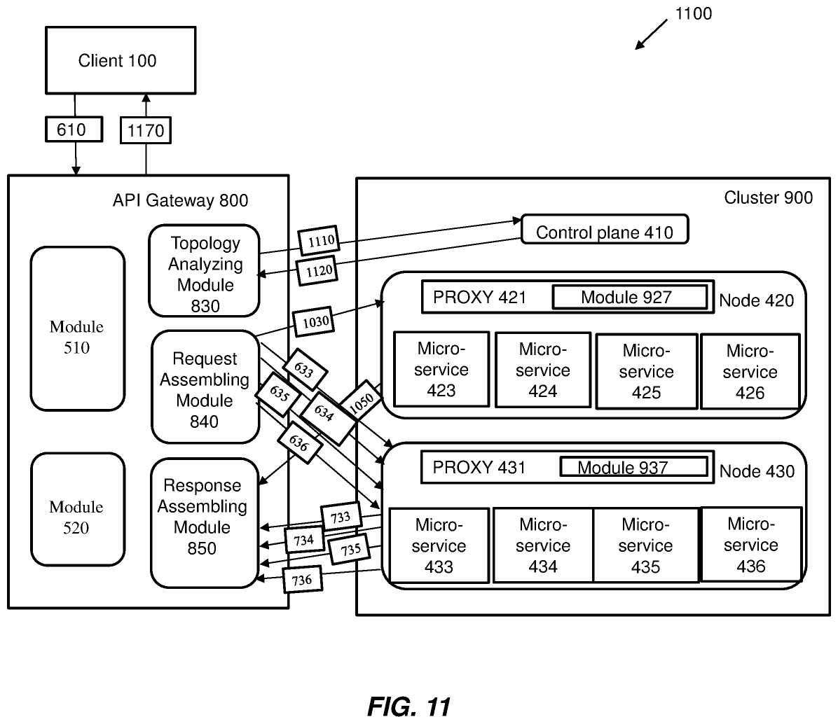

FIG. 11 is a functional block diagram of a second micro-service architecture within a distributed computing framework, generally designated 1100, including API gateway 800 depicted in FIG. 8 and second cluster 900 depicted in FIG. 9 in accordance with at least one embodiment of the present invention.

As explained above, when requests are merged requests, additional actions may need to be introduced to nodes. For example, module 927 may be deployed to carry out the extra actions (for example, splitting and merging, etc.) on proxy 421 of node 420. In the case in which the health (for example, CPU utilization, failure rate in certain time span, such as, in the past 1 hour, in the past 30 minutes, in the past 20 minutes, in the past 10 minutes are at a reasonable level) of a node is sufficient (above a predetermined threshold), these additional actions may be processed. However, if the health of a node is insufficient (below a predetermined threshold), these additional actions may not be processed.

In some embodiments, and as shown in FIG. 11, because of the health of the nodes, merging actions may be partially applied partly to some requests, for example, requests 623, 624, 625, 626. In some embodiments, requests 623, 624, 625, 626 may be merged into merged request 1030, but requests 633, 634, 635, 636 remain the same as shown in FIG. 6. As explained above, request assembling module 840 may determine how to assemble the requests. For example, the mapping information acquired by module 830 may further include the health status of the nodes. A health index may be used to characterize the health status of the nodes. The health index may include CPU utilization, failure rate in certain time span, such as, in the past 1 hour, in the past 30 minutes, in the past 20 minutes, in the past 10 minutes, etc. The CPU utilization may show if the node is ready for processing or not, and failure rate in certain time span, such as, in the past 1 hour, in the past 30 minutes, in the past 20 minutes, in the past 10 minutes may demonstrate recent processing quality history. It should be understood that other parameters may also be used to characterize the health status of the nodes. A threshold may be used to determine whether or not a node can take on the above mentioned additional actions for merging requests and responses in accordance with embodiments of the present invention. For example, in some embodiments, the threshold for a “healthy” node may be set to “70%”, in which lower than “70%” may mean a node is busy and a delay will occur. On the other hand, above 70% may mean a node is not busy and no to little delay will occur. As explained in the previous paragraphs, based on the mapping information, request assembling module 840 may decide which bundle of requests are suitable for merging. In some embodiments, the health status of a node may be a further factor that is taken into consideration when determining which requests are suitable for merging.

After module 510 obtains the request list of the request 610 and splits the request 610 into multiple requests (for example, eight requests, similar as in FIG. 6) as shown in FIG. 11, topology analyzing module 830 may send request 1110 to control plane 410 for mapping information of the services included in the request 610. A response 1120 may be given associated with the mapping information, such as mapping relationships between the requests and the nodes, the health status of the nodes, etc.

In some embodiments, after receiving the response 1120 from control plane 410, request assembling module 840 may merge requests based on the mapping information. For example, it may be determined from the response 1120 that requests 623, 624, 625, 626 may be assigned to node 420 since the health status (e.g., 48%) of node 420 is below 70%, and the requests 633, 634, 635, 636 may be assigned to node 430 since the health status (e.g., 88%) of node 430 is below 70%. Based on the above information, request assembling module 840 may determine to select requests 623, 624, 625, 626 as candidate requests for merging because of the requests mapping to a same node 420 having a good health condition (e.g., the health status is 88% which is above the acceptable threshold of 70%). On the other hand, request assembling module 840 may determine to not select requests 633, 634, 635, and 636 as candidate requests for merging because of the requests mapping to a same node 430 having a poor health condition (e.g., the health status is 48% which is below the acceptable threshold of 70%). Thus, requests 623, 624, 625, 626 which will be processed by node 420 may be merged into merged request 1030, but requests 633, 634, 635, 636 which will be processed by node 430 may not be merged. A mergedID which is used to identify the merging status may additionally be generated for merged request 1030.

An exemplary service list, request list, request 1110 and response 1120 is provided below as Example 6.

### Example 6

### Service List

423, 424, 425, 426, 433, 434, 435, 436

| RequestIDs | Request URL |
|---|---|
| 623 | Https://dataplatform.cloud.ibm.com/api/423 |
| 624 | Https://dataplatform.cloud.ibm.com/api/424 |
| 625 | Https://dataplatform.cloud.ibm.com/api/425 |
| 626 | Https://dataplatform.cloud.ibm.com/api/426 |
| 633 | Https://dataplatform.cloud.ibm.com/api/433 |
| 634 | Https://dataplatform.cloud.ibm.com/api/434 |
| 635 | Https://dataplatform.cloud.ibm.com/api/435 |
| 636 | Https://dataplatform.cloud.ibm.com/api/436 |

### Request 1110:

URL: Https://dataplatform.cloud.ibm.com/apis/currentNodeServiceMap

### Body:

{
“service list”:[ 423, 424, 425, 426, 433, 434, 435, 436],
}

### Response 1120:

```
{
    “423”:{
    “node”:”Node420”,
    “healthy”:”68%”
      },
  “424”:{
    “node”:”Node420”,
        “healthy”:”68%”
      },
    “425”:{
        “node”:”Node420”,
        “healthy”:”68%”
      },
    “426”:{
          “node”:”Node420”,
          “healthy”:”68%”
      },
    “433”:{
          “node”:”Node430”,
          “healthy”:”72%”
      },
    “434”:{
          “node”:”Node430”,
          “healthy”:”72%”
      },
    “435”:{
          “node”:”Node430”,
          “healthy”:”72%”
      },
    “436”:{
          “node”:”Node430”,
          “healthy”:”72%”
      }
    }
```

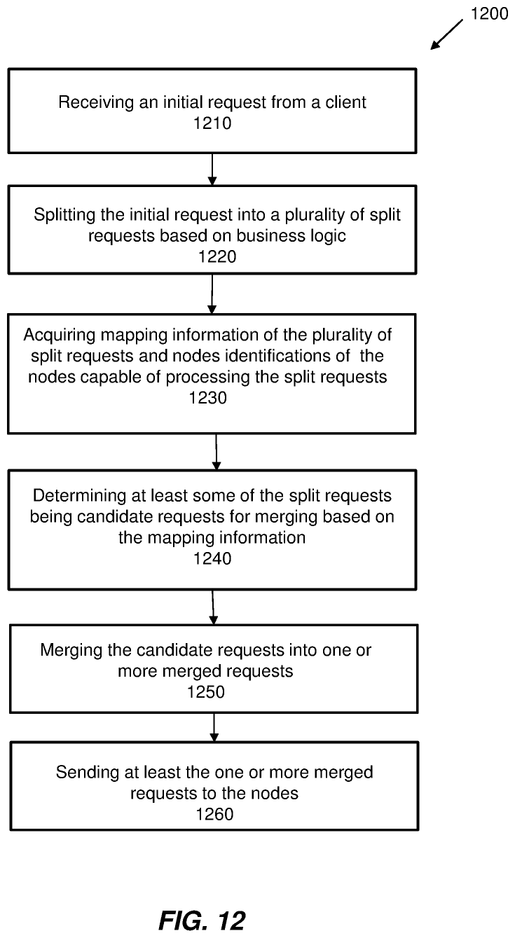

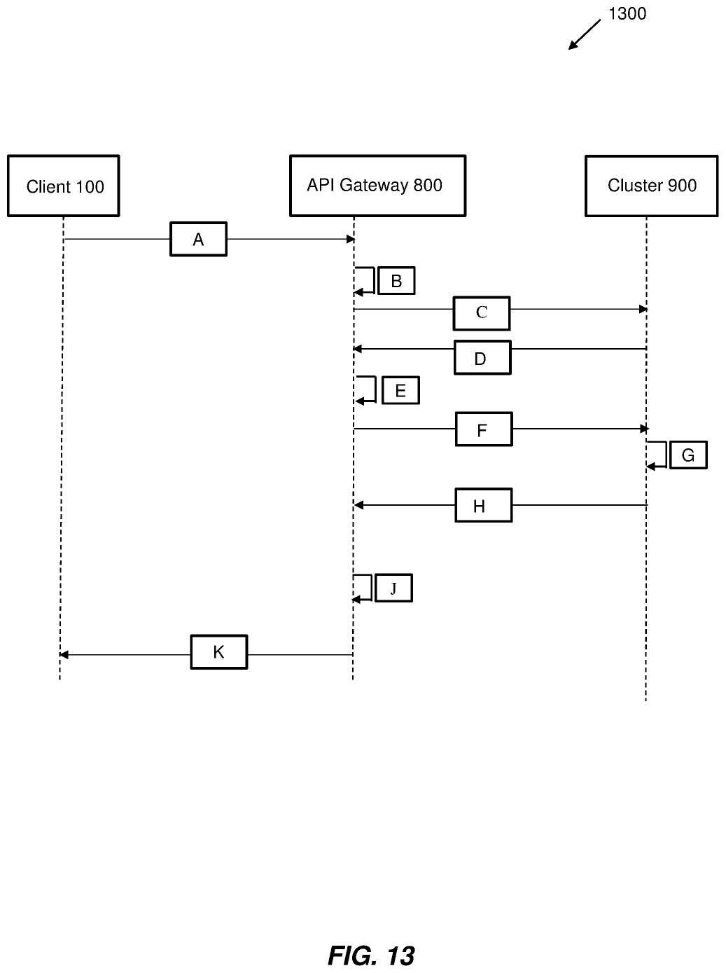

FIG. 12 is a flowchart diagram, generally designated 1200, depicting a method for reducing network latency in a micro-service architecture within a distributed computing framework in accordance with at least one embodiment of present invention. FIG. 13 is a block diagram, generally designated 1300, depicting respective corresponding operational steps of the flowchart diagram 1200 of FIG. 12.

In some embodiments, the method can be implemented based on a micro-service architecture, for example, the micro-service architecture 1000 in FIG. 10, the micro-service architecture 1100 in FIG. 11, or the like. In some embodiments, the method may be implemented by a computing device, for example, cloud computing node 100 of FIG. 1. Specifically, the method may be implemented by an API gateway (for example, API gateway 800 of FIG. 8) of a micro-service architecture (for example, micro-service architecture 1000 in FIG. 10, micro-service architecture 1100 in FIG. 11, or the like).

As shown in FIG. 12, at step 1210, the API gateway (e.g., module 510 in FIG. 10) may receive an initial request from a client.

In some embodiments, the client 100 may send an initial request to the API gateway 800 at stage A (shown in FIG. 13). Correspondingly, the API gateway 800 may receive the initial request from the client 100.

At step 1220, the API gateway 800 (e.g., module 510 in FIG. 10) may split the initial request into a plurality of split requests based on business logic.

In some embodiments, and as shown in FIG. 13, API gateway 800 (e.g., module 510 in FIG. 10) may slit the initial request 610 into split requests 623, 624, 625, 626, 633, 634, 635, 636 at stage B.

At step 1230, the API gateway (e.g., topology analyzing module 830 in FIG. 10) may acquire mapping information associated with the plurality of split requests and information associated with those nodes that are capable of processing the split requests.

In some embodiments, topology analyzing module 830 may send a request to control plane 410 for mapping information of the services included in the initial request at stage C (shown in FIG. 13). Topology analyzing module 830 may then receive a response 1020 associated with mapping information, such as mapping relationships between the split requests and the nodes, the health status of the nodes, or the like at stage D (shown in FIG. 13).

At step 1240, the API gateway (e.g., request assembling module 840 in FIG. 10) may determine at least some of the split requests that are candidate requests for merging based on the related mapping information.

Request assembling module 840 may determine the candidate requests based on the mapping relationships at stage E (shown in FIG. 13). In some embodiments, two or more requests being mapped to a same node may be determined to be suitable candidate requests. In other embodiments, request assembling module 840 may also consider the health status of the nodes when determining whether requests are suitable candidate requests. That is, the node (e.g., node 420 as shown in FIG. 11) which is mapped to some of the requests (e.g., requests 623, 624, 625, 626 in FIG. 11), may also need to have a good health condition, otherwise, the related requests (for example, requests 633, 634, 635, 636) may not be determined to be candidate requests.

At step 1250, the API gateway (e.g., request assembling module 840 in FIG. 10) may merge the candidate requests into one or more merged requests at stage E (shown in FIG. 13).

In some embodiments, request assembling module 840 may merge the candidate requests 623, 624, 625, 626 into a merged request 1030, and may also merge requests 633, 634, 635, 636 into a merged request 1040 (as shown in FIG. 10). In other embodiments, request assembling module 840 may merge requests 623, 624, 625, 626 into merged request 1030, but may not merge requests 633, 634, 635, 636 into merged request 1040 if the health status of the corresponding node 430 is not above a predetermined threshold (as shown in FIG. 11).

At step 1260, the API gateway (e.g., request assembling module 840 in FIG. 10) may send at least the merged requests to the nodes.

Request assembling module 840 may send all the requests to the nodes at stage F (shown in FIG. 13). In some embodiments, request assembling module 840 may send merged requests 1030, 1040 to nodes 420, 430 respectively (as shown in FIG. 10). In other embodiments, request assembling module 840 may send merged request 1030 to node 420 and send split requests 633, 634, 635, 636 to node 430 (as shown in FIG. 11).

In some embodiments, request assembling module 840 may send the requests to the proxy of each node. Merged requests may be processed by a module deployed on the proxy of each node at stage G (shown in FIG. 13). For example, as shown in FIG. 10, module 927 may be deployed on proxy 421, and module 937 may be deployed on proxy 431. Module 927 may split the merged request 1030 into requests 623, 624, 625, 626, and module 937 may split the merged request 1040 into requests 633, 634, 635, 636. Proxy 421 may distribute the requests to the respective micro-services 423, 424, 425, 426. Similarly, proxy 431 may distribute the requests to the respective micro-services 433, 434, 435, 436. Moreover, micro-services 423, 424, 425, 426 may process the requests 623, 624, 625, 626 (as shown in FIG. 6) and send the responses 723, 724, 725, 726 to proxy 421 (as shown in FIG. 7). Similar actions may be done to requests 633, 634, 635, 636, and responses 733, 734, 735, 736. Module 927 may gather responses 723, 724, 725, 726, and merge responses 723, 724, 725, 726 into merged response 1050. Then, module 927 may send the merged response 1050 to response assembling module 850 which is deployed on API gateway 800 at stage H (shown in FIG. 13).

In some embodiments, module 937 may gather responses 733, 734, 735, 736, and merge responses 733, 734, 735, 736 into merged response 1060 at stage G (shown in FIG. 13) in a similar way, and may further forward the merged response 1060 to response assembling module 850 at stage H (shown in FIG. 13). Response assembling module 850 can be used to process the responses according to the requests and further based on needs of module 520 (as shown in FIG. 8). In some further embodiments, response assembling module 850 may merge merged response 1050 and merged response 1060 into a merged response 1070 (“final response”) and send the merged response 1070 (“final response”) to module 520 at stage J (shown in FIG. 13). Module 520 may finally send the merged response to client 100 at stage K (shown in FIG. 13).

In some embodiments, request assembling module 840 may not merge requests 633, 634, 635, 636, and requests 633, 634, 635, 636 may be sent to proxy 431 directly. In this scenario, module 927 may act in a similar way as described above. However, module 937 may not perform any merging actions (e.g., as described with reference to FIG. 11). Rather, proxy 431 may receive requests 633, 634, 635, 636 and distribute each of the requests 633, 634, 635, 636 to the respective micro-services 433, 434, 435, 436. After being processed by micro-services 433, 434, 435, 436, responses 733, 734, 735, 736 may be gathered. In some embodiments, proxy 431 may further forward responses 733, 734, 735, 736 together with merged response 1050 which is processed by module 927 to response assembling module 850 at stage H (show in FIG. 13). Response assembling module 850 may process the response 1050 and the responses 733, 734, 735, 736 according to the needs of module 520 at stage J (shown in FIG. 13). In some embodiments, response assembling module 850 may merge the response 1050 and the responses 733, 734, 735, 736 into a merged response 1170 (“final response”) and send the merged response 1170 (“final response”) to module 520 at stage J (shown in FIG. 13). Module 520 may finally send the merged response to client 100 at stage K (shown in FIG. 13).

What is claimed is:

1. A computer-implemented method, comprising:
receiving, by one or more processors, an initial request from a client;
splitting, by one or more processors, the initial request into a plurality of split requests based on a business logic;
acquiring, by one or more processors, mapping information associated with the plurality of split requests;
determining, by one or more processors, respective split requests included in the plurality of split requests that are candidates for merger into a merged request based, at least in part, on the mapping information;
merging, by one or more processors, the respective split requests that are determined to be candidates for merger into one or more merged requests; and
sending, by one or more processors, the one or more merged requests to one or more nodes capable of processing the one or more merged requests.

2. The computer-implemented method of claim 1, wherein determining respective split requests included in the plurality of split requests that are candidate for meter into a merged request is based, at least in part, on:
mapping, by one or more processors, the plurality of split request to respective nodes for processing the plurality of split requests; and
determining, by one or more processors, respective split requests that are mapped to a same node.

3. The computer-implemented method of claim 2, wherein determining respective split requests included in the plurality of split requests that are candidate for meter into a merged request is further based on:
determining, by one or more processors, that a health status of the same node that the respective split requests are mapped to is above a predetermined threshold.

4. The computer-implemented method of claim 1, further comprising:
receiving, by one or more processors, responses to the one or more merged requests from the one or more nodes capable of processing the one or more merged requests.

5. The computer-implemented method of claim 4, wherein at least one of the responses to the one or more merged requests from the one or more nodes capable of processing the one or more merged requests is a merged response.

6. The computer-implemented method according to claim 5, wherein the merged response is merged by a node.

7. The computer-implemented method of claim 6, wherein the one or more merged requests are split into a plurality of requests by a proxy deployed on the node.

8. The computer-implemented method of claim 7, wherein the merged response is merged from a plurality of responses corresponding to the plurality of requests split from the one or more merged requests by the proxy deployed on the node.

9. The computer-implemented method of claim 1, wherein each merged request is identified by a mergedID.

10. The computer-implemented method of claim 5, wherein each merged response shares a same mergedID with a corresponding merged request.

11. The computer-implemented method of claim 5, further comprising:
merging, by one or more processors, the one or more merged responses into a final response; and
returning, by one or more processors, the final response to the client corresponding to the initial request.

12. A computer system comprising:
one or more computer processors;
one or more computer readable storage media; and
computer program instructions;
the computer program instructions being stored on the one or more computer readable storage media for execution by the one or more computer processors; and
the computer program instructions including instructions to:
receive an initial request from a client;
split the initial request into a plurality of split requests based on a business logic;
acquire mapping information associated with the plurality of split requests;
determine respective split requests included in the plurality of split requests that are candidates for merger into a merged request based, at least in part, on the mapping information;
merge the respective split requests that are determined to be candidates for merger into one or more merged requests; and
send the one or more merged requests to one or more nodes capable of processing the one or more merged requests.

13. The computer system of claim 12, wherein the program instructions to determine respective split requests included in the plurality of split requests that are candidate for meter into a merged request is based, at least in part, on program instructions to:
map the plurality of split request to respective nodes for processing the plurality of split requests; and
determine respective split requests that are mapped to a same node.

14. The computer system of claim 13, wherein the program instructions to determine respective split requests included in the plurality of split requests that are candidate for meter into a merged request is further based on program instructions to:
determine that a health status of the same node that the respective split requests are mapped to is above a predetermined threshold.

15. The computer system of claim 14, further comprising program instructions to:
receive responses to the one or more merged requests from the one or more nodes capable of processing the one or more merged requests.

16. The computer system of claim 12, further comprising program instructions to:
merge the one or more merged responses into a final response; and
return the final response to the client corresponding to the initial request.

17. A computer program product, the computer program product comprising one or more computer readable storage media and program instructions stored on the one or more computer readable storage media, the program instructions including instructions to:
receive an initial request from a client;
split the initial request into a plurality of split requests based on a business logic;
acquire mapping information associated with the plurality of split requests;
determine respective split requests included in the plurality of split requests that are candidates for merger into a merged request based, at least in part, on the mapping information;
merge the respective split requests that are determined to be candidates for merger into one or more merged requests; and
send the one or more merged requests to one or more nodes capable of processing the one or more merged requests.

18. The computer program product of claim 17, wherein the program instructions to determine respective split requests included in the plurality of split requests that are candidate for meter into a merged request is based, at least in part, on program instructions to:
map the plurality of split request to respective nodes for processing the plurality of split requests; and
determine respective split requests that are mapped to a same node.

19. The computer program product of claim 18, wherein the program instructions to determine respective split requests included in the plurality of split requests that are candidate for meter into a merged request is further based on program instructions to:
determine that a health status of the same node that the respective split requests are mapped to is above a predetermined threshold.

20. The computer program product of claim 17, further comprising program instructions to:
merge the one or more merged responses into a final response; and
return the final response to the client corresponding to the initial request.
